(19) United States
(12) Patent Application Publication
(10) Pub. No.: US 2010/0190460 A1
(43) Pub. Date: Jul. 29, 2010

(54) PRE-PROCESSOR FOR RECEIVER ANTENNA DIVERSITY

(75) Inventor: Norman C. Beaulieu, Edmonton (CA)

Correspondence Address: SMART & BIGGAR;P.O. BOX 2999, STATION D, 900-55 METCALFE STREET, OTTAWA, ON, K1P 5Y6, CA

(73) Assignee: THE GOVERNORS OF THE UNIVERSITY OF ALBERTA, EDMONTON, AB (CA)

(21) Appl. No.: 12/602,265

(22) PCT Filed: Apr. 28, 2008
(86) PCT No.: PCT/CA2008/000798

§ 371 Date: Nov. 30, 2009

Related U.S. Application Data
(60) Provisional application No. 60/941,115, filed on May 31, 2007.

(51) Int. Cl. H04B 7/08; H04B 1/06

(52) U.S. Cl. 455/278.1; 455/273

(57) ABSTRACT

A dual-branch decorrelator receiver is provided in which decorrelation is performed with a simple addition and subtraction. The same receiver finds application in pre-processing signals that may not be correlated.

### RELATED APPLICATION

This application claims the benefit of U.S. Provisional Application No. 60/941,115 filed May 31, 2007.

### FIELD OF THE INVENTION

The invention relates to diversity receivers.

### BACKGROUND OF THE INVENTION

It is well known that correlation between the branches of a dual diversity system has a deleterious effect on the performances, outage and average error rate, of the diversity system. Meanwhile, space restrictions may dictate that only correlated diversity branches are available in an application; this is particularly true for a handheld wireless unit. In these cases, correlated dual branches are employed for the gains they provide over a single branch system, even though the gains are reduced relative to independent dual branches. Decorrelation of the correlated branches might be considered to improve the diversity receiver performance. It has been shown that there is no benefit gained from decorrelating correlated branches in an optimal maximal ratio combining (MRC) diversity system. The question remains as to whether the performances of other diversity combining schemes such as selection combining (SC), switch-and-stay combining (SSC), square-law combining (SLC) and equal gain combining (EGC) can be improved by employing decorrelation. In this regard, complexity plays a crucial role. In general, performing a decorrelation of correlated diversity branches requires complex measurement of channel state information for the diversity branches in order to determine the parameters needed to implement complex matrix transformations to effect the decorrelation. Overall, the system becomes more complex than a MRC diversity system, requiring more channel estimation and more signal processing than an optimal MRC system. Thus, MRC is simply to be preferred and decorrelation is impractical.

Many researchers have analyzed the performance of dual-branch diversity systems in independent and correlated fading channels employing several combining schemes such as MRC, EGC, SC and SSC. The performance of coherent as well as noncoherent and differentially coherent modulation methods have been analyzed in dual-branch diversity systems. For example, a unified performance analysis of digital communication systems with dual-branch selective combining diversity over correlated Rayleigh and Nakagami-m fading channels is presented in M. K. Simon and M.-S. Alouini, “A Unified Performance Analysis of Digital Communication with Dual Selective Combining Diversity over Correlated Rayleigh and Nakagami-m Fading Channels,” IEEE Trans. on Commun., vol. 47, pp. 33-43, January 1999.

In a reference by Tsouri, G. R., Wulich, D. and Goldfeld, L. entitled “Enhancing Switched Diversity Systems,” Sensor Array and Multichannel Signal Processing Workshop Proceedings, 2004, pp. 485-488, July 2004, an approach to performing decorrelation between receiver branches prior to performing SC or SSC is taught. The method involves application of the Karhunen-Loeve Transform (KLT) on a set of antenna array outputs to create a set of uncorrelated non-homogeneous diversity branches. The solution is complex in that it involves estimating the covariance matrix of the channel and the subsequent derivation of the KLT from the covariance matrix of the channel, which requires time and processor intensive matrix calculations. In addition, the solution assumes a Rayleigh fading channel, one where there is no line of sight between the receiver and the transmitter.

### SUMMARY OF THE INVENTION

According to one broad aspect of the present invention, there is provided a branch signal pre-processor for selection and switched diversity comprising: a summer to determine a sum of a first branch signal and a second branch signal to produce a sum signal; and a differencer to determine a difference of the first branch signal and the second branch signal to produce a difference signal; and a diversity combiner configured to combine the sum signal and the difference signal.

In some embodiments, the first branch signal and the second branch signal are respective antenna samples, intermediate frequency signal samples, or base-band samples.

In some embodiments, the first branch signal and the second branch signal are respective continuous signals.

In some embodiments, the diversity combiner is configured to perform at least one of: a) selection combining (SC); and b) switch-and-stay combining (SSC).

In some embodiments, the summer comprises at least one of: a) an operational amplifier; and b) an antenna transformer.

In some embodiments, the differencer comprises at least one of: a) an operational amplifier; and b) an antenna transformer.

In some embodiments, the branch signal pre-processor further comprises a plurality of decorrelators, respectively configured to decorrelate respective pairs of branch signals received from respective pairs of antennas, said first branch signal and said second branch signal being one such pair of branch signals.

In some embodiments, The branch signal pre-processor further comprises a gain control element configured to apply a gain to at least one of: a) the first branch signal; and b) the second branch signal.

In some embodiments, the gain of the gain control element is selected to equalize power of the first branch signal and the second branch signal.

In some embodiments, the diversity combiner is configured to perform SC combining by: determining which one of the sum signal and the difference signal has a higher signal to noise ratio (SNR); and selecting the one of the sum signal and the difference signal that has the higher SNR for data detection.

In some embodiments, the diversity combiner is configured to perform SC combining on the basis of a signal-plus-noise criterion for the sum and the difference signals.

In some embodiments, the diversity combiner is configured to perform SC combining on the basis of a signal-to-interference-plus-noise criterion for the sum and the difference signals.

In some embodiments, the diversity combiner is configured to perform SSC combining by: determining a current SNR for a currently selected one of the sum signal and the difference signal; determining if the current SNR for the currently selected one of the sum signal and the difference signal is above a threshold; maintaining the selection of the currently selected one of the sum signal and the difference signal upon determining that the current SNR for the currently selected one of the sum signal and the difference signal is above the threshold; and switching the selection to the other one of the sum signal and the difference signal upon determining that the current SNR for the currently selected one of the sum signal and the difference signal is below the threshold.

In some embodiments, the diversity combiner if further configured to select the threshold as a function of the current SNR.

In some embodiments, the diversity combiner is configured to perform SSC combining on the basis of a signal-plus-noise criterion for the sum and the difference signals.

In some embodiments, the diversity combiner is configured to perform SSC combining on the basis of a signal-to-interference-plus-noise criterion for the sum and the difference signals.

In some embodiments, a receiver is provided that comprises: the above-summarized branch signal pre-processor; a first antenna, the first branch signal based upon a signal received by the first antenna; a second antenna, the second branch signal based upon a signal received by the second antenna.

According to another broad aspect of the present invention, there is provided a method comprising: obtaining a first branch signal and a second branch signal; determining a sum of the first branch signal and the second branch signal to produce a sum signal; and determining a difference of the first branch signal and the second branch signal to produce a difference signal; and performing a diversity combining operation upon the sum signal and the difference signal.

In some embodiments, obtaining a first branch signal and a second branch signal comprises determining the first branch signal from a signal received through a first antenna and determining the second branch signal from a signal received through a second antenna.

In some embodiments, performing a diversity combining operation comprises performing selection combining.

In some embodiments, performing a diversity combining operation comprises performing switch-and-stay combining (SSC).

In some embodiments, a method performing gain control on at least one of the first branch signal and the second branch signal.

In some embodiments, performing gain control on at least one of the first branch signal and the second branch signal is performed to equalize power of the first branch signal and the second branch signal.

In some embodiments, the method further comprises selecting the threshold as a function of a current SNR.

In some embodiments, the method of further comprises: performing a respective sum operation on each of a plurality of pairs of branch signals to produce a respective sum signal, one of the pairs of branch signals consisting of the first branch signal and the second branch signal; performing a respective difference operation on each of the plurality of branch signals to produce a respective difference signal; performing a combining operation based on the sum signals and the difference signals.

According to another broad aspect of the present invention, there is provided a method comprising: obtaining a plurality N of branch signals, where N>=3; determining 2^{N} or 2^{N-1} outputs each of which is a respective combination of the N inputs with a different permutations of signs; performing a diversity combining operation upon the 2^{N} or 2^{N-1} outputs to produce a combiner output.

### BRIEF DESCRIPTION OF THE DRAWINGS

Embodiments of the invention will now be described with reference to the attached drawings in which:

FIG. 1 is a plot of normalized mean output SNRs of a conventional EGC receiver and a decorrelator EGC receiver in accordance with an embodiment of the present invention as a function of the correlation, ρ, in correlated Rician fading for K=3, 6 and 9;

FIG. 2 is a plot of average BER (bit error rate) of BPSK (binary phase shift keying) for a conventional SC receiver and a decorrelator SC receiver in accordance with an embodiment of the present invention as a function of the average SNR per bit per branch in correlated Rician fading with ρ=0.55 for K=0, 5 and 10;

FIG. 3 is a plot of average BER of BPSK for a conventional SC receiver and a decorrelator SC receiver in accordance with an embodiment of the present invention as a function of the average SNR per bit per branch in correlated Rician fading with K=5 for ρ=0.1, 0.5 and 0.9;

FIG. 4 is a plot of outage probability of a conventional SC receiver and a decorrelator SC receiver in accordance with an embodiment of the present invention as a function of the normalized outage threshold SNR per branch in correlated Rician fading with ρ=0.5 for K=0, 5 and 10;

FIG. 5 is a plot of outage probability of a conventional SC receiver and a decorrelator SC receiver in accordance with an embodiment of the present invention as a function of the normalized outage threshold SNR per branch in correlated Rician fading with K=6 for ρ=0.1, 0.4 and 0.8;

FIG. 6 is a plot of average output SNR of a conventional SC receiver and a decorrelator SC receiver in accordance with an embodiment of the present invention as a function of the average SNR per symbol in correlated Rician fading with ρ=0.5 for K=0, 5 and 10;

FIG. 7 is a plot of average BER of QFSK (quadrature frequency shift keying) for a conventional SSC receiver and a decorrelator SSC receiver in accordance with an embodiment of the present invention as a function of the average SNR per bit per branch in correlated Rician fading with ρ=0.6 for K=0, 5 and 10;

FIG. 8 is a plot of average BER of QFSK for a decorrelator SSC receiver in accordance with an embodiment of the present invention as a function of the switching threshold in correlated Rician fading with K=5 and ρ=0.1, 0.5 and 0.9 for γ̅=10, 15 and 25 dB;

FIG. 9 is a plot of average BER of MFSK (M-ary frequency shift keying) for a conventional SSC receiver and a decorrelator SSC receiver in accordance with an embodiment of the present invention as a function of the average SNR per bit per branch in correlated Rician fading with ρ=0.6 and K=4 for M=2, 4 and 16;

FIG. 10 is a plot of average output SNR of a conventional SSC receiver and a decorrelator SSC receiver in accordance with an embodiment of the present invention as a function of the average SNR per symbol in correlated Rician fading with K=10 for ρ=0.15, 0.45 and 0.75;

FIG. 11 is a block diagram of a branch signal pre-processor for dual selection and switched diversity in accordance with an embodiment of the present invention;

FIG. 12 is a block diagram of another branch signal pre-processor for dual selection and switched diversity in accordance with an embodiment of the present invention;

FIG. 13 is a block diagram of another branch signal pre-processor for dual selection and switched diversity in accordance with an embodiment of the present invention;

FIG. 14 is a block diagram of another branch signal pre-processor for selection and switched diversity in accordance with an embodiment of the present invention; and

FIG. 15 is a block diagram of another branch signal pre-processor for selection and switched diversity in accordance with an embodiment of the present invention.

### DETAILED DESCRIPTION OF EMBODIMENTS

In the special case of dual diversity, a method of performing decorrelation is provided that can be economically implemented using simple addition and subtraction of the correlated signals without any channel state information, regardless of the value of the correlation coefficient between the branches, provided that the channels have the same average power. If the fading is Rician, or complex Gaussian, the decorrelated branches are independent branches, albeit of different mean powers. The addition of simple, economical adder circuits as signal pre-processing ahead of SC, SSC or EGC diversity combining is both practical and consistent with the otherwise simple and economical implementations of these diversity combining schemes. Receivers that implement one of these approaches will be referred to as “decorrelator receivers”.

It is assumed for illustration that the branches have the same average fading power and the branches are generally correlated with correlation coefficient ρ. Slow, flat fading is assumed. In the decorrelator receiver the branches are first decorrelated and then diversity combining is performed on the decorrelated branches. It is shown that to decorrelate the incoming signals, the receiver does not need any information about the signals and the decorrelation can be done by adding and subtracting the signals on the two diversity branches. Important performance measures such as the mean output signal-to-noise ratio (SNR), outage probability, average symbol error rate (SER) and average bit error rate (BER) of several modulation schemes of practical interest are computed for each combiner. The performance of the decorrelator diversity receiver with SC and SSC is compared to the performance of the conventional SC and SSC receiver, respectively, and it is shown that the decorrelator receiver has superior performance in terms of the average BER, outage probability and mean output SNR. For example, for binary phase shift keying (BPSK) and at an average BER of 10⁻⁴, the SNR improvement of the decorrelator receiver over the conventional receiver is as much as 2.1 dB in correlated Rician fading. The effects of modulation order, correlation and the severity of fading on the relative performances of the conventional and the decorrelator receivers are examined. It is noted that using the results of X. Dong and N. C. Beaulieu, “Optimal maximal ratio combining with correlated diversity branches,” IEEE Commun. Lett., vol. 6, pp. 22-24, April 2002., one can show that the performance of the decorrelator MRC receiver and the conventional MRC receiver are identical. The performance of the decorrelator SLC receiver and the conventional SLC receiver are also identical. For EGC, the performance of the decorrelator EGC receiver is inferior to the performance of the conventional EGC receiver.

### System Model

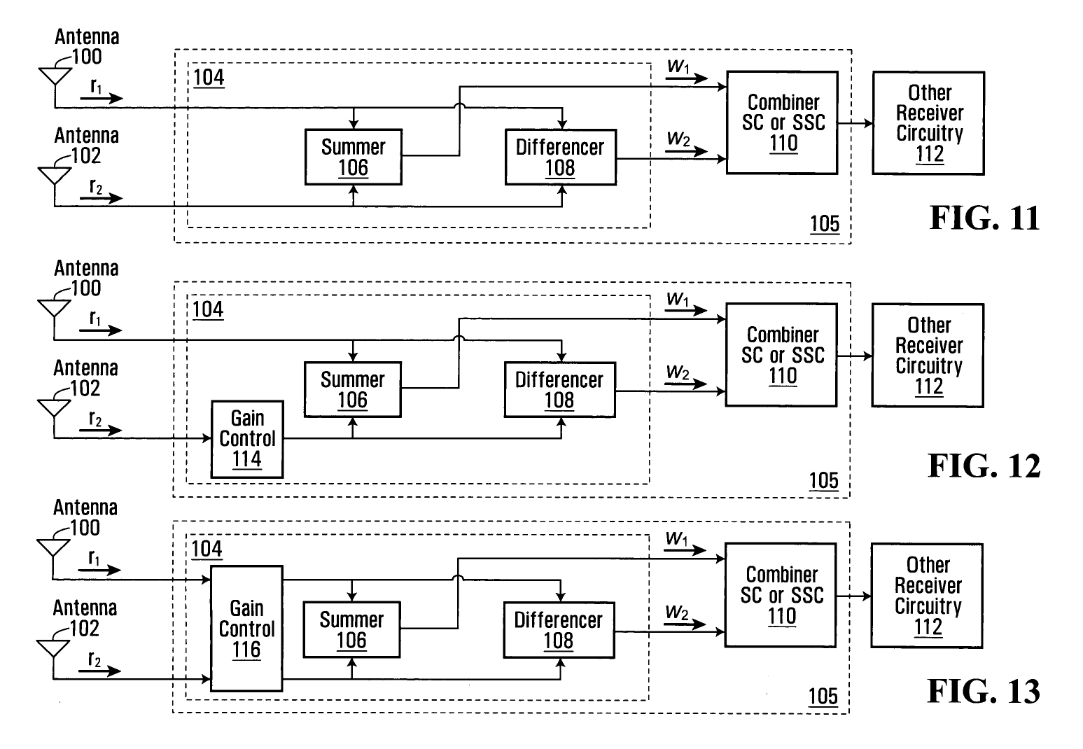

FIG. 11 illustrates a block diagram of a receiver featuring a branch signal pre-processor in accordance with an embodiment of the present invention. The branch signal pre-processor is generally indicated at 105 and includes a decorrelator 104 and a combiner 110. The branch signal pre-processor 105 is connected between a pair of antennas 100,102 and the rest of the circuitry of the receiver, which is shown as the Other Receiver Circuitry block 112 in FIG. 11.

In FIG. 11, the decorrelator 104 includes a summer 106 and a differencer 108. The summer 106 and the differencer 108 both have two signal inputs, which are respectively connected to the antennas 100,102. The summer 106 and the differencer 108 each have a respective signal output that is connected to a respective signal input of the combiner 110.

In FIG. 11, the combiner 110 is shown as being operable to implement either selection combining (SC) or switch-and-stay combining (SSC), which are described in further detail below. More generally, the combiner 110 in the illustrated example implements at least one of SC and SSC combining. Other types of combining are possible, such as combining methods involving space-time coding.

For the description of the operation of the example of FIG. 11 and the examples of FIGS. 12 and 13 detailed below, the signals operated upon by the de-correlation operation are referred to as “branch signals”. In the examples described, it is assumed the branch signals operated upon by the de-correlation operation are antenna signal samples, radio frequency signal samples, intermediate frequency signal samples or base-band samples obtained for each of the signals received at the two antennas 100,102, that the branch signal pre-processor produces de-correlated samples, and that the combiner 110 operates on the de-correlated samples. However, it is to be understood that a sampling operation need not occur prior to de-correlation; the de-correlation operation can occur on a continuous basis on branch signals that are two continuous signals received via the two antennas 100,102. In any event, there may also be some intermediate steps to produce the branch signals upon which the de-correlation operation takes place, such as demodulation or down conversion. Furthermore, a sampling operation need not necessarily occur prior to the combining operation. To be general, sampling may occur before de-correlation, before combining, or not at all as part of the pre-processing operation.

In FIG. 11, branch signals r₁ and r₂ denote the received base-band equivalent signal samples at the first and second branch, respectively, given by

r₁=g₁x+n₁ (1)

r₂=g₂x+n₂ (2)

In (1) and (2) x is the data symbol sample, gᵢ, i=1, 2 are the complex channel gains and nᵢ, i=1, 2 are independent complex additive white zero-mean Gaussian noise samples with variance N₀/2 per dimension. It is assumed for illustration that the fadings on the branches are identically distributed and the instantaneous and average signal-to-noise ratios on each branch are given by γ and γ̅, respectively.

It is further assumed that the fading on the branches are slow and frequency flat Rician faded and are correlated with correlation coefficient ρ. It is useful in the subsequent development to represent the channel gains as (see Y. Chen and C. Tellambura, “Distribution functions of selection combiner output in equally correlated Rayleigh, Rician, and Nakagami-m fading channels,” IEEE Trans. Commun., vol. 52, pp. 1948-1956, November 2004)

gᵢ=\sqrt{1−ρ}Uᵢ+\sqrt{ρ}U₀+m₁+j(\sqrt{1−ρ}Vᵢ+\sqrt{ρ}V₀+m₂), i=1, 2 (3)

where 0≦ρ≦1 and Uᵢ and Vᵢ are independent zero-mean Gaussian random variables (RVs) with variance σ²=Ω/(2(K+1)), and where K=(m₁²+m₂²)/(2σ²) is the Rician factor (see G. L. Stuber, Principles of Mobile Communication, 2nd ed. Norwell, M A: Kluwer Academic Publishers, 2001). Using the representation given in (3), one can show that the fading correlation between g₁ and g₂ is equal to ρ and E[|gᵢ|²]=Ω, i=1, 2, i.e., the branches are identically statistically distributed. In addition, the power correlation, ρ_{η}, between |g₁|² and |g₂|² can be obtained as

$${ρ}_{η} = ρ \frac{2 K + ρ}{2 K + 1} \qquad ( 4 )$$

Signal samples r₁ and r₂ are input to the decorrelator 104. The outputs of the decorrelator 104, denoted as w₁ and w₂, are given by

$$\begin{matrix}{w}_{1} = \frac{{r}_{1} + {r}_{2}}{\sqrt{2}} = \frac{{g}_{1} + {g}_{2}}{\sqrt{2}} x + \frac{{n}_{1} + {n}_{2}}{\sqrt{2}} ≡ {G}_{1} x + {v}_{1} & ( 5 ) \\ {w}_{2} = \frac{{r}_{1} - {r}_{2}}{\sqrt{2}} = \frac{{g}_{1} - {g}_{2}}{\sqrt{2}} x + \frac{{n}_{1} - {n}_{2}}{\sqrt{2}} ≡ {G}_{2} x + {v}_{2} & ( 6 )\end{matrix}$$

Since g₁ and g₂ are complex Gaussian RVs, one can see from the definition of G₁ and G₂ that these are also complex Gaussian RVs. Furthermore, one can show that G₁ and G₂ are uncorrelated and thus independent. Similarly, one can prove that the noise terms v₁ and v₂ are mutually independent Gaussian RVs with variance N₀/2 per dimension. Furthermore, it can be shown that the noise components v₁ and v₂ are independent of each other and also independent of the signal components in w₁ and w₂. Thus, the decorrelator 104 transforms the two correlated branches into two independent branches. The outputs of the decorrelator 104 are input into the diversity combiner 110.

The functionality of the summer 106 and the differencer 108 may be implemented separately or in a single combined element. The summer 106 and the differencer 108 may be a passive electrical network or an active electrical network, or one or a combination of software running on a processor, hardware, firmware.

In some embodiments, an operational amplifier is used to implement the functionality of the summer 106 and the differencer 108.

In some embodiments, an antenna transformer is used to implement the functionality of the summer 106 and the differencer 108.

In some embodiments, the gain of the antennas 100,102 are not equal, or the powers of the received signals are unequal. In some embodiments, a gain control element, such as an amplifier, is connected in one of the antenna branches to equalize the gain of the two antennas 100, 102.

FIG. 12 illustrates an example of a branch signal pre-processor for dual selection and switched diversity in accordance with an embodiment of the present invention in which a gain control block 114 is connected in the second antenna branch between the second antenna 102 and the signal inputs of the summer 106 and the differencer 108 to adjust the gain of the second antenna branch.

The gain control block 114 provides a gain, a, such that the gain control block 114 receives the signal r₂ from the second antenna 102 and then applies the gain a to the signal r₂ so that the summer 106 and the differencer 108 receive ar₂ on their respective second signal inputs.

The outputs wᵢ and w₂ of the decorrelator 104 are then given by:

$$\begin{matrix}{w}_{1} = \frac{{r}_{1} + {ar}_{2}}{\sqrt{2}} & ( 7 ) \\ {w}_{2} = \frac{{r}_{1} - {ar}_{2}}{\sqrt{2}} & ( 8 )\end{matrix}$$

In some embodiments, the gain of the gain control block 114 is selected to equalize the gain of the first antenna 100 and the second antenna 102. For example, the gain of the gain control block 114 may be selected according to:

$$Gain a = \sqrt{\frac{Power of Signal from Ante nna 100}{Power of Signal form Antenna 102}} \qquad ( 9 )$$

In some embodiments, the gain provided by the gain control block 114 is selected to provide a gain to the second antenna branch that is unequal to the gain of the first antenna branch.

In some embodiments, an assumption of the type of channels over which the antennas 100,102 receive signals is a factor in determining the gain a of the gain control block 114. For example, the gain a of the gain control block 114 may be different if a Rician fading channel is assumed, rather than if a Rayleigh fading channel is assumed.

In some embodiments, a gain control block is provided in both the first branch and the second branch of the branch signal pre-processor. FIG. 13 illustrates an example of a branch signal pre-processor for dual selection and switched diversity in accordance with an embodiment of the present invention in which both the second antenna branch and the first antenna branch are connected to a gain control block 116. The gain control block 116 has a first input connected to the first antenna 100 and a second input connected to the second antenna 102. The gain control block 116 has a first output and a second output connected to respective inputs of both the summer 106 and the differencer 108.

The gain control block 116 applies a gain to at least one of the first branch signal r₁ and the second branch signal r₂.

In some embodiments, the gain control block 116 applies a differential gain to the first branch signal r₁ and the second branch signal r₂ in order to equalize the powers of branch signals r₁, r₂ if they are unequal.

### Selection Combining

In selection combining the branch with the largest SNR is chosen for data detection. The branches used are of course the decorrelated branches, and as such they are no longer in a one-to-one relationship with the receive antennas. Let γ₁ and γ₂ denote the instantaneous SNR for w₁ and w₂, respectively. A diversity combiner operable to perform selection combining will then select the decorrelated branch with the larger instantaneous SNR γ₁ or γ₂.

While the embodiments described assume that selection combining is performed on the basis of SNR, other criterion can be used to decide to switch. In some embodiments, the decision to switch is based on the received signal-plus-noise sample. Similarly, the signal-to-interference plus noise (SINR) is used in another embodiment as a criterion to decide when to switch. Other criteria are possible.

### Switch-and-Stay Combining

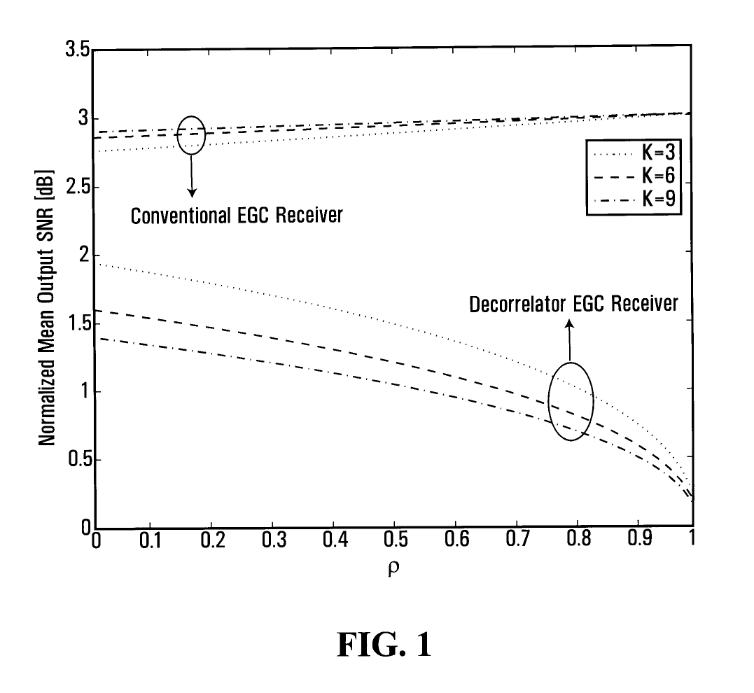

The SSC scheme operates as follows. Let γ_{SSC}(n) denote the output of the switch at time t=nT. As before let γ₁(n) and γ₂(n) denote, respectively, the instantaneous SNR of the outputs of the decorrelator at time t=nT. The system operates as follows. The combiner, for example combiner 110 of FIG. 1, has a switch that is connected to only one of two possible de-correlated signals w₁, w₂. Assume that the switch is connected to receive w₁. The switch will remain connected to w₁ as long as the SNR on that channel is above a predetermined threshold, γ_{T}. If the SNR on that channel falls below γ_{T}, the system will switch to the other branch (w₁) regardless of the SNR on that branch. In mathematical terms, γ_{SSC}(n) can be written as (see A. A. Abu-Dayya and N. C. Beaulieu, “Analysis of Switched Diversity Systems on Generalized fading Channels,” IEEE Trans. Commun., vol. 42, pp. 2959-2966, November 1994)

$$\begin{matrix}γ ssc ( n ) = {γ}_{1} ( n ) ii f \{ \begin{matrix}γ ssc ( n - 1 ) = {γ}_{1} ( n - 1 ) & {γ}_{1} ( n ) \geq γ r \\ γ ssc ( n - 1 ) = {γ}_{2} ( n - 1 ) & {γ}_{2} ( n ) < γ r\end{matrix} & ( 10 ) \\ γ ssc ( n ) = {γ}_{2} ( n ) ii f \{ \begin{matrix}γ ssc ( n - 1 ) = {γ}_{2} ( n - 1 ) & {γ}_{2} ( n ) \geq γ r \\ γ ssc ( n - 1 ) = {γ}_{1} ( n - 1 ) & {γ}_{1} ( n ) < γ r\end{matrix} & ( 11 )\end{matrix}$$

While the embodiments described assume that switch and stay combining is performed on the basis of SNR, other criterion can be used to decide to switch. In some embodiments, the decision to switch is based on the received signal-plus-noise sample. Similarly, the signal-to-interference plus noise (SINR) is used in another embodiment as a criterion to decide when to switch. Other criteria are possible.

### Numerical Examples

Important performance measures such as the mean output signal-to-noise ratio (SNR), outage probability, average symbol error rate (SER) and average bit error rate (BER) of several modulation schemes of practical interest are computed for each combiner. The performance of the decorrelator diversity receiver with SC and SSC is compared to the performance of the conventional SC and SSC receiver, respectively, and it is shown that the decorrelator receiver has superior performance in terms of the average BER, outage probability and mean output SNR. For example, for binary phase shift keying (BPSK) and at an average BER of 10⁻⁴, the SNR improvement of the decorrelator receiver over the conventional receiver is as much as 2.1 dB in correlated Rician fading. The effects of modulation order, correlation and the severity of fading on the relative performances of the conventional and the decorrelator receivers are examined. It is noted that using the results of X. Dong and N. C. Beaulieu, “Optimal maximal ratio combining with correlated diversity branches,” IEEE Commun. Lett., vol. 6, pp. 22-24, April 2002, one can show that the performance of the decorrelator receiver and the conventional receiver with MRC are identical. The performance of the decorrelator receiver and the conventional receiver are also identical when SLC is employed at the receiver. For EGC, the performance of the decorrelator receiver is inferior to the performance of the conventional receiver.

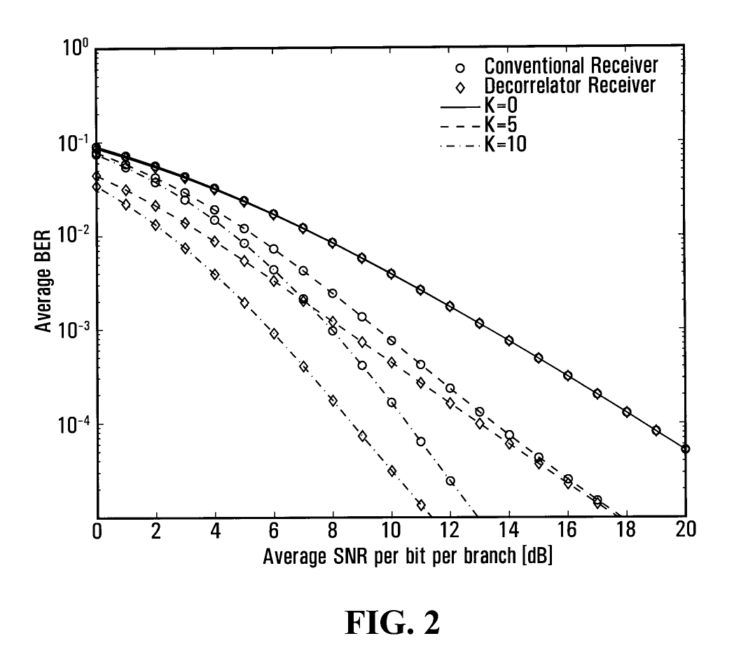

FIG. 2 shows the average BER of BPSK for the conventional and the decorrelator SC receivers as a function of the average SNR per bit per branch in correlated Rician fading with ρ=0.55 and for several values of K=0, 5 and 10. Note that for K=0, which corresponds to Rayleigh fading, the performances of the two receivers are almost identical and the decorrelator receiver performs slightly better than the conventional receiver for small values of SNR. However, in Rician fading, the performance of the decorrelator receiver is significantly better than the performance of the conventional receiver and the performance improves as the channel becomes less faded (K increases). For example, FIG. 2 shows that for K=10 and for an average BER of 10⁻³, the average SNR difference between the conventional and the decorrelator receiver is 2.1 dB.

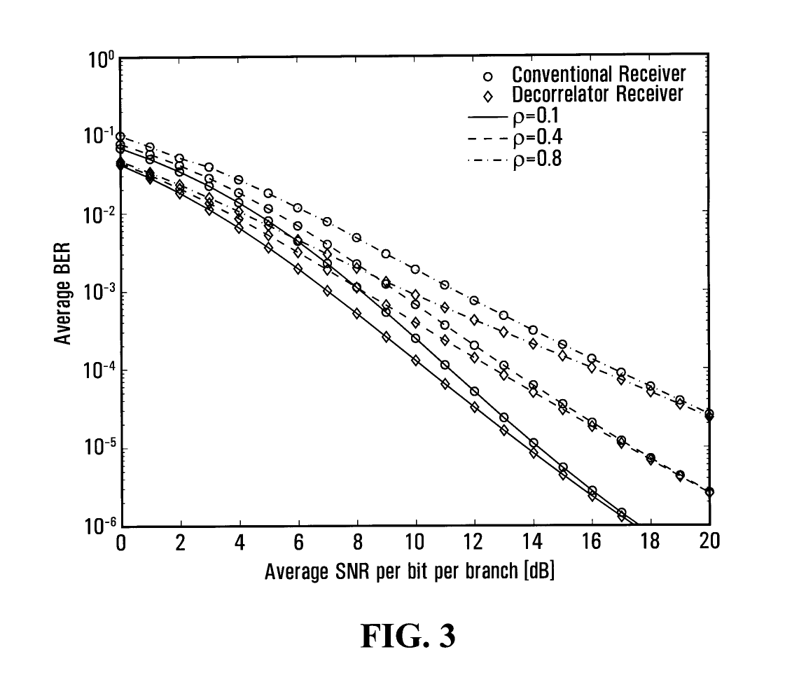

FIG. 3 shows the effect of correlation on the relative performance of the conventional and the decorrelator SC receivers in correlated Rician fading with K=5 and 10 for ρ=0.1, 0.4 and 0.8. FIG. 3 shows that the decorrelator receiver outperforms the conventional receiver for the whole range of SNR. For example, at an average BER of 10⁻⁴, the SNR gain of decorrelator receiver over the conventional receiver is 0.77 dB, 0.54 dB and 0.63 dB for ρ=0.1, ρ=0.4 and ρ=0.8, respectively.

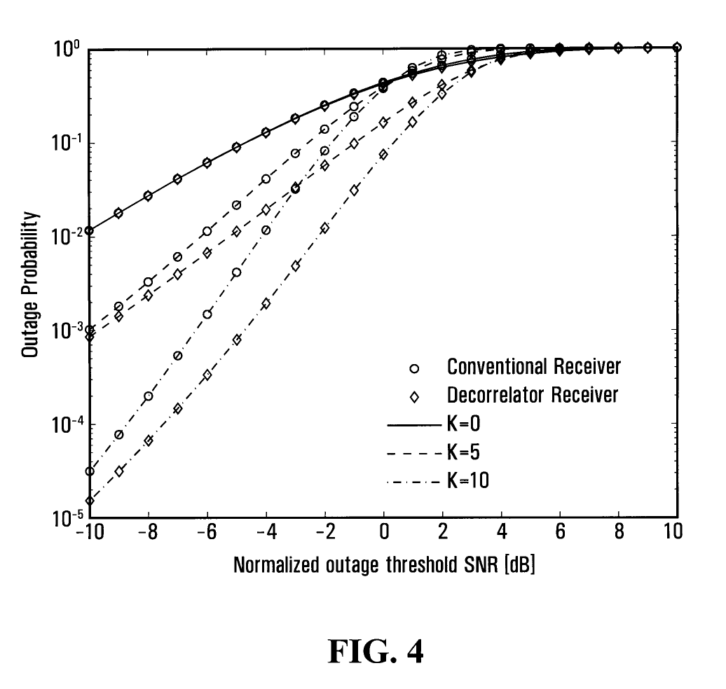

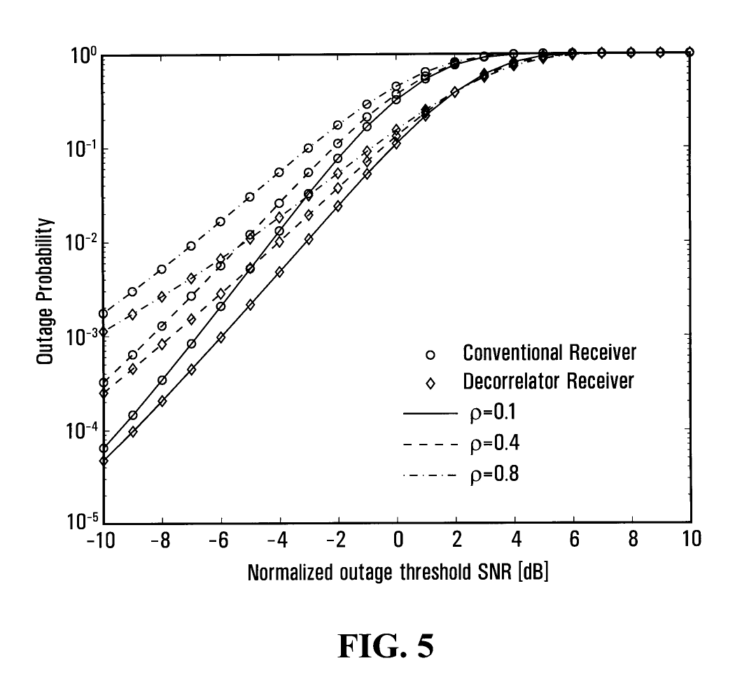

The outage probabilities of the conventional and the decorrelator SC receivers in correlated Rician fading are plotted in FIGS. 4 and 5 for several values of K and ρ as a function of the normalized outage threshold SNR. Both figures show that the outage probability of the decorrelator receiver is much less than the outage probability of the conventional receiver. For example, FIG. 4 shows that for a normalized outage threshold SNR of −4 dB and for K=10, the outage probability of the conventional and the decorrelator receiver are 0.0115 and 0.0019, respectively which means that the outage probability of the decorrelator receiver is one-sixth of that of the conventional receiver. Note also that FIG. 4 indicates that as K increases and for a given normalized outage threshold SNR, the difference between the outage performance of the two receivers increases.

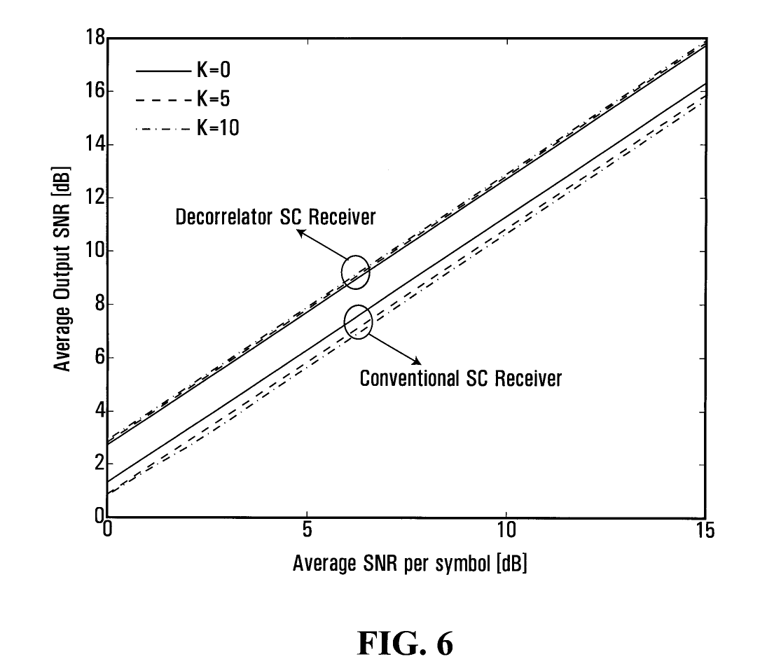

In FIG. 6 the mean output SNR of the conventional and the decorrelator SC receivers in correlated Rician fading with ρ=0.5 have been plotted for several values of K=0, 5 and 10. FIG. 6 indicates that unlike the conventional SC receiver where the mean output SNR decreases as K increases, the mean output SNR increases as K increases in the decorrelator SC receiver.

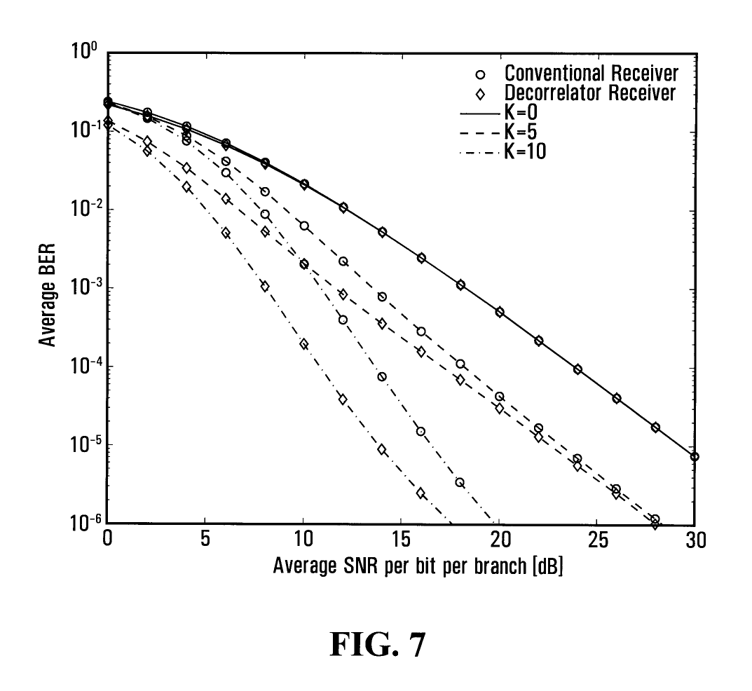

FIG. 7 shows the average BER of QFSK with the conventional and the decorrelator SSC receiver as a function of average SNR per bit per branch in correlated Rician fading with ρ=0.6 and K=0, 5 and 10. To plot the curves in FIG. 7, for each value of SNR, the optimum switching threshold that minimizes the average BER has been used. FIG. 7 shows that the performance of the decorrelator receiver is superior to the performance of the conventional receiver and the performance gap increases as K increases. For example, at an average BER of 10⁻⁴ the SNR gap between the conventional and the decorrelator receiver is 2.83 dB and 1.11 dB for K=5 and K=10, respectively. For K=0, the performances of the two receivers are almost identical for moderate to large values of average SNR. For small values of average SNR, however, the decorrelator receiver performs slightly better.

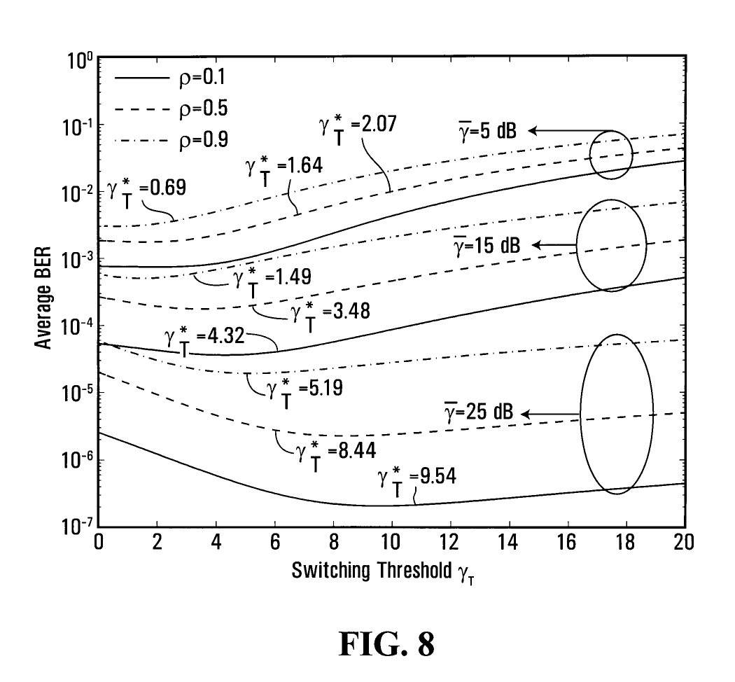

The dependence of the average BER of QFSK with the decorrelator SSC receiver in correlated Rician fading on the switching threshold is studied in FIG. 8 for several values of γ̅ and ρ. FIG. 8 shows that for a fixed γ̅, the optimum switching threshold increases as ρ decreases. FIG. 8 also indicates that for a fixed ρ, the optimum switching threshold increases as γ̅ increases.

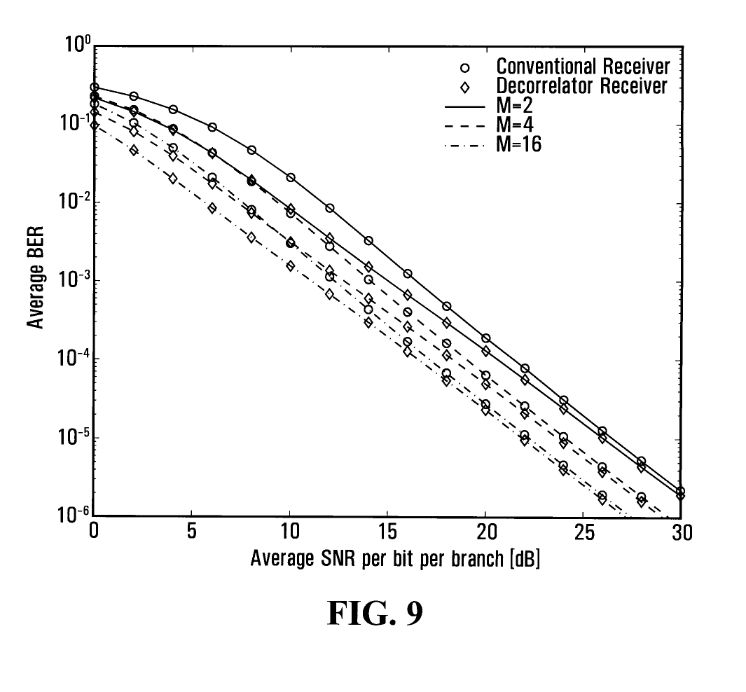

The effect of modulation order M on the average BER of MFSK with the decorrelator and the conventional SSC receiver is shown in FIG. 9 for several values of M=2, 4 and 16. Again, similar to FIG. 9, for each SNR value, the optimum switching threshold that minimizes the average BER is computed. FIG. 9 shows that for a given average BER the performance gap between the two receivers does not change significantly with M. For example, at an average BER of 10⁻³, the SNR gap between the two receivers is 1.44 dB, 1.05 dB and 1.19 dB for M=2, 4 and 16, respectively.

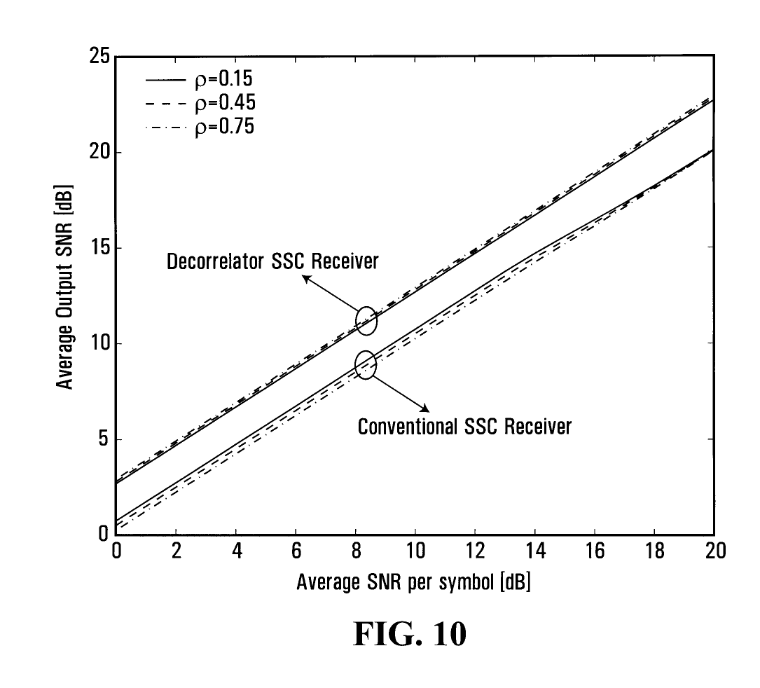

Finally, the mean output SNRs of the conventional and the decorrelator receiver with SSC in correlated Rician fading with K=10 are compared in FIG. 10 for several values of correlation ρ=0.15, 0.45 and 0.75. FIG. 10 shows that unlike the conventional SSC receiver and for a fixed average SNR, the mean output SNR of the decorrelator SSC receiver increases as the channel becomes less faded. FIG. 10 also indicates that the mean output SNR of the decorrelator receiver is much larger than that of the conventional receiver. For each value of average SNR in FIG. 10, the optimum switching threshold that maximizes the mean output SNR has been computed. These optimum switching thresholds have been calculated by obtaining the roots of (12) numerically, where γ̅_{SSC} is the mean output SNR and γ_{T} is the switching threshold.

d γ̅_{SSC}/dγ_{T}=0 (12)

FIG. 10 shows that the mean output SNR of the decorrelator SSC receiver is less sensitive to the changes in the correlation than the mean output SNR of the conventional SSC receiver for small to medium average SNR.

An interesting behaviour evidenced in FIGS. 3, 5 and 10 is that the performance of the decorrelator receiver improves with increasing correlation coefficient while that of the conventional receiver degrades with increasing correlation coefficient. This happens because the correlation increases the SNR of the stronger decorrelated branch while decreasing the SNR of the weaker decorrelated branch, so that the effective SNR of the selected branch generally improves with increasing correlation.

While the foregoing has been described in the context of a branch signal pre-processor for dual (two antenna) selection and switched diversity, embodiments of the present invention may also be applied to antenna receiver systems with more than two antennas. For example, the techniques described above could be used to pre-process multiple receiver antennas two-by-two. That is, a plurality of antennas could be pre-processed two at a time in accordance with the foregoing methods and systems.

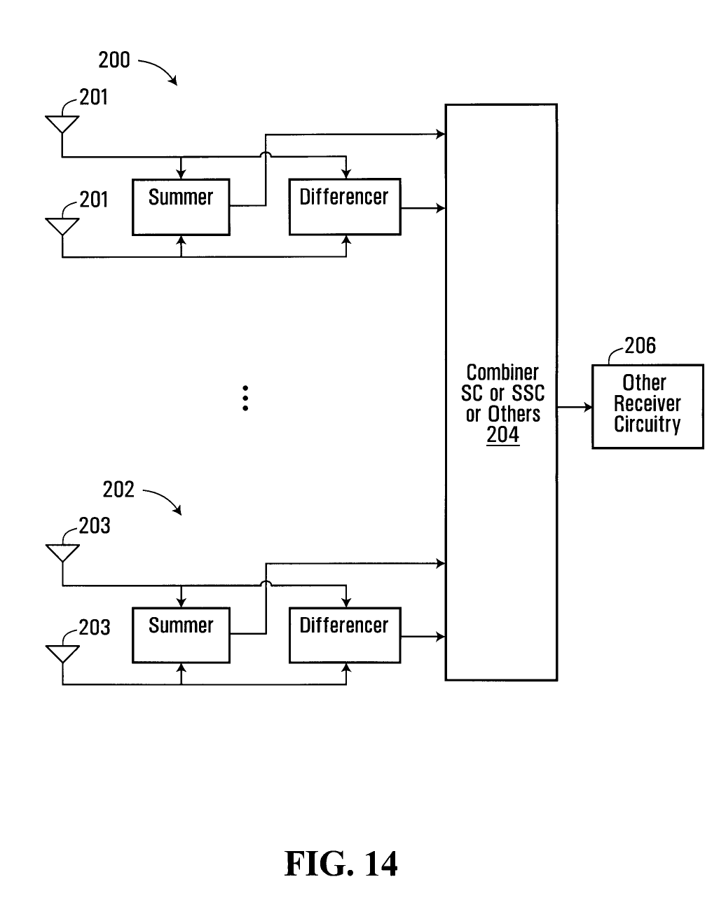

An example of this is shown in FIG. 14 where for a plurality of pairs of antennas 201,203 (only two pairs shown), there is a summer-differencer 200,202. Each summer-differencer 200,202 produces a sum signal and a difference signal as described previously, and all of the sums and differences go into a combiner 204 that performs a SC, SSC or other combining operation to produce an output for other receiving circuitry 206.

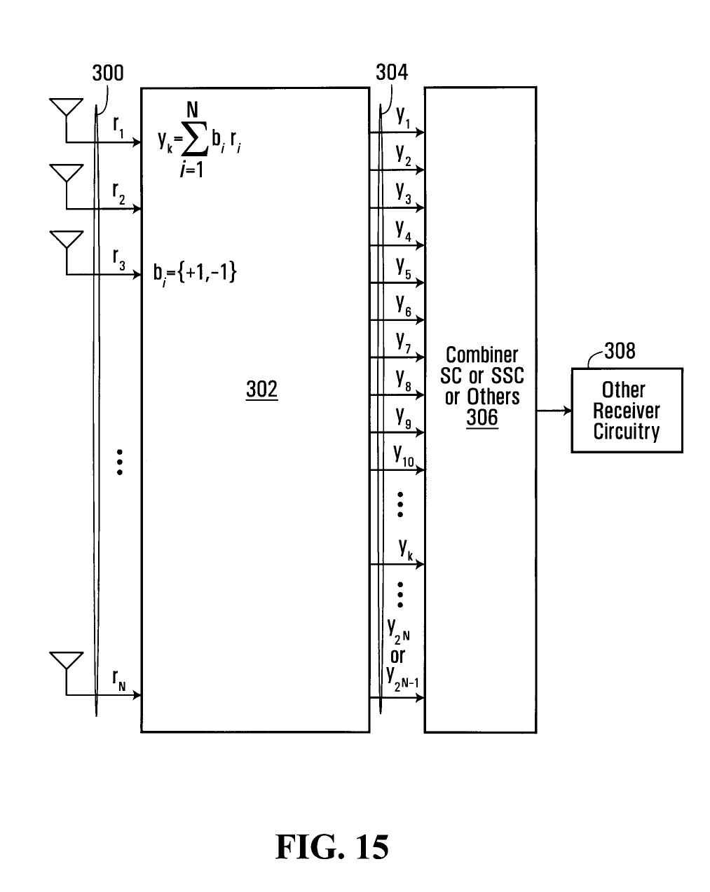

In another embodiment, rather than processing multiple antennas pairwise, as in the embodiment of FIG. 14, all of the antennas are processed together. An example of this is shown in FIG. 15. Shown is a set of N antennas and N associated branch signals r₁, r₂, . . . , r_{N}. For this embodiment, it is assumed that N>2, since N=2 will be equivalent to the 2 antenna case detailed previously. These are input to summer-differencer 302. Summer-differencer 302 has a set of 2^{N} or 2^{N-1} outputs that are input to a combiner 306 that might perform SC, SSC or some other type of combining. The output of the combiner 306 is fed to other receiver circuitry 308.

In operation, the summer-differencer 302 computes either 2^{N} or 2^{N-1} outputs that are possible from combining each of the N inputs with different permutations of signs. If 2^{N-1} outputs are computed, half of these will be the negative of the others. This is why it is possible to operate with only 2^{N-1} outputs. Each output has the form:

$${y}_{k} = {\sum }_{i = 1}^{N} {b}_{i} {r}_{i} \qquad ( 13 )$$

where each bᵢ belongs to the set {+1, −1}. The combiner 306 then selects one of these to pass on to the other receiver circuitry 308. Various selection criteria can be applied as described for previous embodiments.

The above-described embodiments have referred to the pre-processing operation as involving a de-correlation step. For correlated signals, the operation described is in fact a de-correlation. However, more generally, the embodiments can be applied to perform a pre-processing operation on signals that are not correlated, and a performance gain is still realized. Thus, the more generalized pre-processor can be described as having a summer that determines a sum of the first branch signal and the second branch signal to produce a sum signal; and a differencer that determines a difference of the first branch signal and the second branch signal to produce a difference signal. The sum of the two signals is larger than the difference if their phase difference is between −90 degrees and +90 degrees and the difference is a smaller signal. similarly, the difference between the two signals is larger than the sum if their phase difference is between +90 degrees and 270 degrees. This is true regardless of correlation. In the event the branch signals are correlated, the summer and the differencer in combination will perform a decorrelation operation, and the sum and difference signals are the respective decorrelated signals discussed previously

Numerous modifications and variations of the present invention are possible in light of the above teachings. It is therefore to be understood that within the scope of the appended claims, the invention may be practiced otherwise than as specifically described herein.

We claim:

1. A branch signal pre-processor for selection and switched diversity comprising:
a summer to determine a sum of a first branch signal and a second branch signal to produce a sum signal; and
a differencer to determine a difference of the first branch signal and the second branch signal to produce a difference signal; and
a diversity combiner configured to combine the sum signal and the difference signal.

2. The branch signal pre-processor of claim 1 wherein the first branch signal and the second branch signal are respective antenna samples, intermediate frequency signal samples, or base-band samples.

3. The branch signal pre-processor of claim 1 wherein the first branch signal and the second branch signal are respective continuous signals.

4. The branch signal pre-processor of claim 1 wherein the diversity combiner is configured to perform at least one of:
a) selection combining (SC); and
b) switch-and-stay combining (SSC).

5. The branch signal pre-processor of claim 1 wherein the summer comprises at least one of:
a) an operational amplifier; and
b) an antenna transformer.

6. The branch signal pre-processor of claim 1 wherein the differencer comprises at least one of:
a) an operational amplifier; and
b) an antenna transformer.

7. The branch signal pre-processor of claim 1 further comprising a plurality of pre-processors, respectively configured to pre-process respective pairs of branch signals received from respective pairs of antennas, said first branch signal and said second branch signal being one such pair of branch signals.

8. The branch signal pre-processor of claim 1 further comprising a gain control element configured to apply a gain to at least one of:
a) the first branch signal; and
b) the second branch signal.

9. The branch signal pre-processor of claim 8 wherein the gain of the gain control element is selected to equalize power of the first branch signal and the second branch signal.

10. The branch signal pre-processor of claim 4 wherein the diversity combiner is configured to perform SC combining by:
determining which one of the sum signal and the difference signal has a higher signal to noise ratio (SNR); and
selecting the one of the sum signal and the difference signal that has the higher SNR for data detection.

11. The branch signal pre-processor of claim 4 wherein the diversity combiner is configured to perform SC combining on the basis of a signal-plus-noise criterion for the sum and the difference signals.

12. The branch signal pre-processor of claim 4 wherein the diversity combiner is configured to perform SC combining on the basis of a signal-to-interference-plus-noise criterion for the sum and the difference signals.

13. The branch signal pre-processor of claim 4 wherein the diversity combiner is configured to perform SSC combining by:
determining a current SNR for a currently selected one of the sum signal and the difference signal;
determining if the current SNR for the currently selected one of the sum signal and the difference signal is above a threshold;
maintaining the selection of the currently selected one of the sum signal and the difference signal upon determining that the current SNR for the currently selected one of the sum signal and the difference signal is above the threshold; and
switching the selection to the other one of the sum signal and the difference signal upon determining that the current SNR for the currently selected one of the sum signal and the difference signal is below the threshold.

14. The branch signal pre-processor of claim 13 wherein the diversity combiner if further configured to select the threshold as a function of the current SNR.

15. The branch signal pre-processor of claim 4 wherein the diversity combiner is configured to perform SSC combining on the basis of a signal-plus-noise criterion for the sum and the difference signals.

16. The branch signal pre-processor of claim 4 wherein the diversity combiner is configured to perform SSC combining on the basis of a signal-to-interference-plus-noise criterion for the sum and the difference signals.

17. A receiver comprising:
the branch signal pre-processor of claim 1;
a first antenna, the first branch signal based upon a signal received by the first antenna;
a second antenna, the second branch signal based upon a signal received by the second antenna.

18. A method comprising:
obtaining a first branch signal and a second branch signal;
determining a sum of the first branch signal and the second branch signal to produce a sum signal; and
determining a difference of the first branch signal and the second branch signal to produce a difference signal; and
performing a diversity combining operation upon the sum signal and the difference signal.

19. The method of claim 18 wherein
obtaining a first branch signal and a second branch signal comprises determining the first branch signal from a signal received through a first antenna and determining the second branch signal from a signal received through a second antenna.

20. The method of claim 18 wherein performing a diversity combining operation comprises performing selection combining.

21. The method of claim 18 wherein performing a diversity combining operation comprises performing switch-and-stay combining (SSC).

22. The method of claim 18 further comprising performing gain control on at least one of the first branch signal and the second branch signal.

23. The method of claim 22 wherein performing gain control on at least one of the first branch signal and the second branch signal is performed to equalize power of the first branch signal and the second branch signal.

24. The method of claim 18 further comprising selecting the threshold as a function of a current SNR.

25. The method of claim 18 further comprising:
performing a respective sum operation on each of a plurality of pairs of branch signals to produce a respective sum signal, one of the pairs of branch signals consisting of the first branch signal and the second branch signal;
performing a respective difference operation on each of the plurality of branch signals to produce a respective difference signal;
performing a combining operation based on the sum signals and the difference signals.

26. A method comprising:
obtaining a plurality N of branch signals, where N>=3;
determining 2^{N} or 2^{N-1} outputs each of which is a respective combination of the N inputs with a different permutations of signs;
performing a diversity combining operation upon the 2^{N} or 2^{N-1} outputs to produce a combiner output.
